(19) United States
(12) Patent Application Publication
(10) Pub. No.: US 2015/0319274 A1
(43) Pub. Date: Nov. 5, 2015

(54) Mobile Device Case With Cable Storage Compartment

(71) Applicant: Kevin McLoughlin, Norristown, PA (US)

(72) Inventor: Kevin McLoughlin, Norristown, PA (US)

(21) Appl. No.: 14/702,003

(22) Filed: May 1, 2015

Related U.S. Application Data
(60) Provisional application No. 61/986,946, filed on May 1, 2014.

(51) Int. Cl. H04M 1/02; B65H 75/44

(52) U.S. Cl. CPC H04M 1/0206; B65H 75/4457

(57) ABSTRACT

The present invention provides a mobile electronic device protective case having a housing with an internal compartment suited for the storage of an electronic device charging cable therein. The housing of the case includes a base, sidewalls extending upward from the base, and an open upper end for enabling use of the buttons, touch screen, and the like of the mobile device within the case. Further, the base includes a mobile device charging cable compartment. The compartment is sized for receiving an electronic device cable therein, wherein the charging cable compartment can follow a serpentine, coiled, or similar arrangement along the base of the present invention in order to accommodate the length of the charging cable therein. Lastly, a movable cover can be provided over the base section in order to maintain the charging cable in place within the compartment.

### CROSS REFERENCE TO RELATED APPLICATION

This application claims the benefit of U.S. Provisional Application No. 61/986,946 filed on May 1, 2014. The above identified patent application is herein incorporated by reference in its entirety to provide continuity of disclosure.

### BACKGROUND OF THE INVENTION

1. Field of the Invention

The present invention relates to an electronic device case. More specifically, the invention relates to a cellular phone case, whereby the case is secured over a cellular phone and comprises an enclosure with an interior designed for supporting a charging cord therein in order to provide convenience when needing to charge a phone or similar electronic device.

Cellular phones have quickly become an essential part of our everyday lives. They are no longer just for communication purposes, but are now used for event planning, directions, games, shopping, business decisions, and internet use. Because of the continually expanded use of these devices, it is rare for people to leave

their homes without them. As such, the enhanced value of mobile devices requires that they remain constantly powered and capable of use in order to enable individuals to continue with their daily routines.

To maintain involvement with social media, work, and friends, individuals are often required to bring a power cord or an additional battery in order to ensure that the devices will last throughout the day. People are left with bringing extra accessories as their only option to remain connected with others because cellphone batteries have a limited life and must be recharged on a daily basis. Most phones have a sufficient charge to last a typical day, however, when an individual is on the go, bringing a charger is often inconvenient and is frequently forgotten. Further, depending on the use of the device, whether roaming when out of the area or using GPS, internet, or playing games, the battery may drain more quickly than expected.

When people bring power cords with them, they are often tossed in a bag or in a pocket. The cords can become tangled in the bag, the charging prongs can become damaged, and/or the cord can become frayed from being bent. While all of the aforementioned downsides to the commonly utilized means for storing power cords are known, there lacks a suitable means for preventing the tangling or damage of the cords. Moreover, there also lacks a device that ensures that your mobile device is always accompanied by a charging cord. Therefore, there is a need for a device that provides convenience when needing to charge a cellular or similar mobile device.

Devices have been disclosed in the prior art that relate to cellular device cases. These include devices that have been patented and published in patent application publications. These devices generally relate to cases with additional storage compartments within or on the body of the case. These devices each satisfy a specific need that traditional cases cannot accommodate. Some of these modified cases provide compartments for housing makeup products while others include docking ports for the removable attachment of headphones from the exterior of the case. Other devices, however, provide cases for other benefits, such as receiving protective inserts for shielding the phone during falls.

Each of these prior art cases, however, fails to provide a storage compartment for a charging cable therein in order to enable an individual to easily, and conveniently charge a mobile device. Further, these prior art devices fail to provide a mobile device case with a back portion having a cover thereon which can be opened in order to store a charging cable. In evidence of the unmet needs displayed by the prior art, it is clear that the present invention substantially diverges in design elements from the prior art and consequently it is clear that there is a need in the art for an improvement to existing mobile device cases. In this regard the instant invention substantially fulfills these needs.

### SUMMARY OF THE INVENTION

In view of the foregoing disadvantages inherent in the known types of mobile device cases now present in the prior art, the present invention provides a new mobile device case wherein the same can be utilized for providing convenience for the user when needing to travel with a charging cable.

It is therefore an object of the present invention to provide a new and improved mobile device case that has all of the advantages of the prior art and none of the disadvantages.

It is another object of the present invention to provide a mobile device case with a back cover which can be opened in order to reveal an internal storage area.

Another object of the present invention is to provide a mobile device case with a compartment for housing a charging cable.

Yet another object of the present invention is to provide a mobile device case with a curved compartment having sidewalls for supporting a charging cable therein.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 displays a perspective view of the present invention as applied to a mobile device.

FIG. 2 displays a perspective view of the base of the present invention.

FIG. 3 displays a view of the present invention having a partially closed cover.

### DETAILED DESCRIPTION OF THE INVENTION

Reference is made herein to the attached drawings. Like reference numerals are used throughout the drawings to depict like or similar elements of the mobile device case. For the purposes of presenting a brief and clear description of the present invention, the preferred embodiment will be discussed as used for supporting a charging cable therein. The figures are intended for representative purposes only and should not be considered to be limiting in any respect.

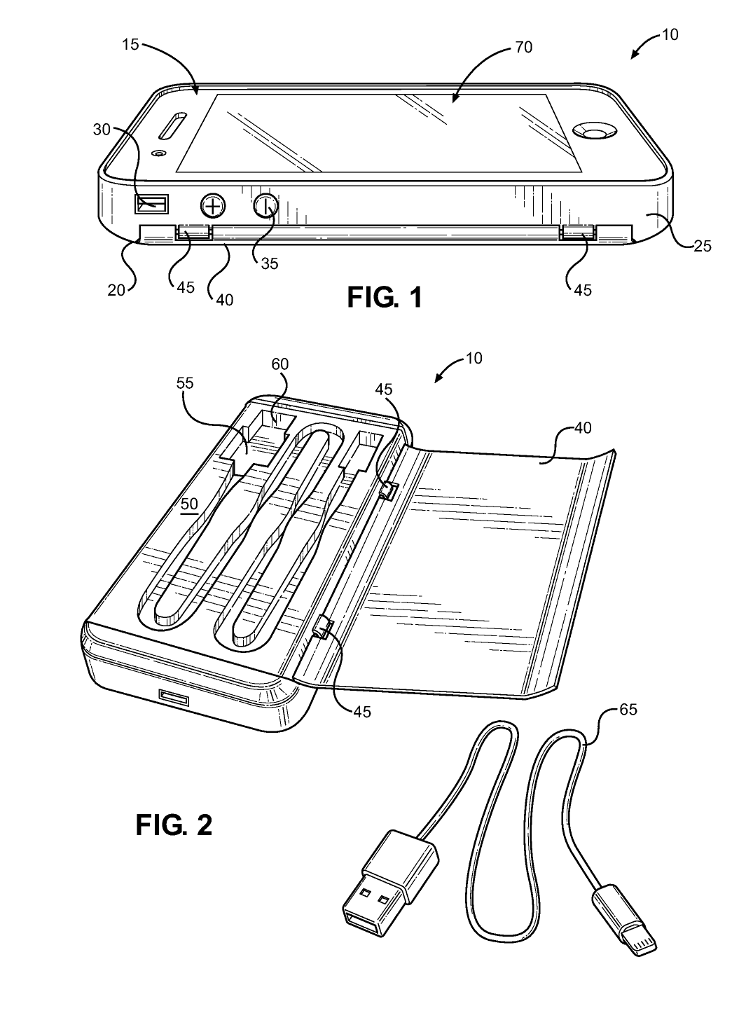

Referring now to FIG. 1, there is shown a perspective view of the present invention as applied to a mobile device. The present invention provides a protective case for a mobile device, such as a cellular phone, tablet computer, or the like. The case 10 provides an improvement over existing mobile device cases by enabling an individual to easily transport a charging cable with a mobile device. This is accomplished by providing an internal, recessed storage compartment within the case, which is sized and shaped for receiving a charging cable therein.

The present invention comprises a mobile device case 10 having an upper, mobile device receiving area with a base section 20 and a sidewall 25 having a lip 15 on the upper end thereof. The case 10 defines an interior volume sized for receiving and maintaining a mobile device 70 therein, wherein the rear of the mobile device 70 rests flush against the base 20 and the sidewalls 25 extend along the sides of the mobile device 70. In this way, the front surface of the mobile device 70 having a touchscreen and controls thereon is not obscured or covered by the case 10. The lip 15 serves to restrain the mobile device 70 within the case 10 so that the mobile device 70 cannot be accidentally removed therefrom. The lip 15, sidewall 25, and base 20 can be composed of a flexible plastic, rubber, or rigid construction. Further, the sidewall 25 can comprise projections 35 for identifying and enabling button depression and also includes various openings 30 for enabling access to ports by charging cables, audio cables, and the like.

Additionally, the case of the present invention includes a cover 40 that overlaps a portion of the base 20. The cover 40 includes a hinge 45 or similar feature which enables the cover 40 to move into and out of covering relation over the base 20. The base 20 includes a compartment for storing a charging cable, wherein the cover 40 can be used to removably cover the compartment so that the charging cable can be maintained therein.

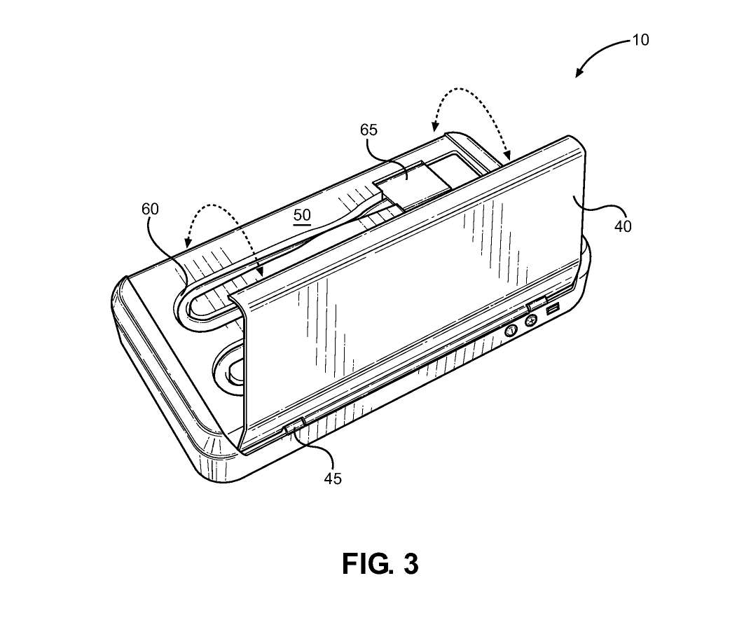

Referring now to FIG. 2, there is displayed an overhead view of the base section 20 of the present invention. The case 10 of the present invention provides convenience by allowing an individual to travel with their charging cord 65. The base 20 includes a base surface 50 with a recessed, storage compartment 55 sized and shaped for holding a charging cord 65 therein. The recessed charging cord containing compartment 55 includes opposed, projecting walls 60 which bring the upper surface of the recessed compartment 55 to a height even with that of the base surface 50. The opposed projecting walls 60 are sized, shaped, and comprise a length suitable for receiving a charging cord 65 therein. The recessed compartment 55 preferably comprises an arcuate, serpentine, spiral, or coiled shape so that the charging cable 65 can be stored in a compact configuration on the base 20 of the case 10. The compartment 55 is shaped similarly to a charging cable and includes enlarged end portions for receiving the ends or plugs of the charging cable. Further, the compartment 55 can include various widths and depths along the wall 60 in order to contain cords 65 differing brands, sizes, and types therein.

A cover 40 is pivotally secured to a portion of the base 20 and can be rotated in order to overlap or enable access to the compartment 55. In this way, the cover can be opened in order to access and remove the charging cable therein, and can be closed when the charging cable is stored. In the closed configuration, the cover rests flush against the base 20 so that the case 10 has a continuous outer surface. In the open configuration, the cover is pivoted away from the base so as to provide access to the storage compartment 55.

Referring now to FIG. 3, there is displayed a view of the present invention having a partially closed cover. The cover 40 comprises a rigid construction and serves as a protection mechanism for the mobile device within the case 10 as well as provide a means for maintaining the charging cord 65 within the device. The cover 40 can be attached to the housing by hinges 45 for enabling the cover to rotate forward or backward in order to allow or restrict access to the interior charging cord compartment 55.

In a primary embodiment, the cover 40 is hingedly attached to the base 20 of the case 10. In other contemplated embodiments, however, the cover 40 can be attached by a slide and lock mechanism or may be entirely removable from the base 20 of the case 10. In any embodiment, however, the cover 40, when closed, secures flush against the sidewall 25 of the housing 10 until removed or otherwise opened by a user.

Overall, the present invention provides a mobile device case 10 that offers convenience when desiring to travel with a charging cable 65. The case 10 of the present invention includes a base 20 with a compartment therein 55 having downwardly projecting walls 60 shaped for receiving a charging cable 65. The projecting walls 60 of the storage compartment 55 have opposing sides for holding a charging cable 65 therein and can include serpentine, coiled, or other arrangements in order to accommodate an elongate cord within the device. Further, the opposing sides of the projecting walls 60 can comprise differing shapes in order to contain cables 65 of different brands and types. The compartment 55 can be concealed by a hinged 45, rigid cover 40 which also functions to maintain the charging cable 65 within the walls 60 of the base section 50. The charging cable 65 can be placed within the back compartment 55 of the present invention 10 as needed in a discrete manner while not adding undue bulkiness to the mobile device case of the present invention 10.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A mobile electronic device case, comprising:
a housing having a base and upstanding sidewalls, defining an interior volume in which a mobile device can be positioned;
a recessed storage compartment on an exterior surface of said base adapted for storage of a charging cable therein;
a cover affixed to said base adapted to removably enclose said storage compartment.

2. The mobile electronic device case of claim 1, wherein said recessed storage compartment comprises a serpentine arrangement.

3. The mobile electronic device case of claim 1, wherein said cover is affixed to said base by one or more hinges.

4. The mobile electronic device case of claim 1, wherein said sidewalls comprise one or more openings adapted to align with one or more buttons or ports on said mobile device when inserted within said housing.

5. The mobile electronic device case of claim 1, wherein said sidewalls comprise one or more projections thereon adapted to align with one or more buttons or ports on said mobile device when inserted within said housing.

6. The mobile electronic device case of claim 1, wherein an upper end of said sidewalls comprises a lip adapted to maintain said mobile device within said interior volume of said housing.
